(19) United States
(12) Patent Application Publication
(10) Pub. No.: US 2018/0231056 A1
(43) Pub. Date: Aug. 16, 2018

(54) CYLINDRICAL ROLLER BEARING

(71) Applicant: NTN CORPORATION, Osaka (JP)

(72) Inventors: Kohei TODA, Mie (JP); Naoki NAKATOCHI, Mie (JP)

(73) Assignee: NTN CORPORATION, Osaka (JP)

(21) Appl. No.: 15/750,028

(22) PCT Filed: Aug. 5, 2016
(86) PCT No.: PCT/JP2016/073073

§ 371 Date: Feb. 2, 2018

(30) Foreign Application Priority Data
Aug. 17, 2015 (JP) 2015-160341

(51) Int. Cl. F16C 33/46; F16C 19/36

(52) U.S. Cl. CPC F16C 33/467; F16C 19/361

(57) ABSTRACT

A cylindrical roller bearing includes a retainer having first anti-separation portions for preventing separation of first cylindrical rollers from respective pockets of the retainer, and second anti-separation portions for preventing separation of second cylindrical rollers from the respective pockets. The axial distance between each first anti-separation portion and the corresponding second anti-separation portion is larger than the lengths of the first cylindrical rollers or the second cylindrical rollers so that one of the two cylindrical rollers which is to be first inserted into each pocket does not have to be pushed into the pocket.

### TECHNICAL FIELD

This invention relates to cylindrical roller bearings in general, and particularly a cylindrical roller bearing of the type including a one-piece retainer having pockets each receiving two cylindrical rollers so as to be axially aligned with each other.

### BACKGROUND ART

Among retainers used in cylindrical roller bearings, a one-piece retainer, which is formed with pockets into which cylindrical rollers are pushed, is, compared to a two-piece retainer, high in strength, and needs a smaller number of assembling steps because it is not necessary to fix two members together by e.g., riveting (see, for example, the below-identified Patent Document 1).

Such a one-piece retainer includes crossbars separating circumferentially adjacent pairs of pockets, and end surface portions on both sides of the pockets and defining the axial widths of the pockets. The retainer further includes anti-separation portions for preventing separation of the cylindrical rollers from the respective pockets. The anti-separation portions for each pocket are spaced apart from each other by a distance smaller than the diameters of the cylindrical rollers so that a cylindrical roller is forcibly pushed through the space between the anti-separation portions into the pocket.

### PRIOR ART DOCUMENT(S)

### Patent Document(s)

Patent Document 1: JP Patent Publication 2006-118644A

### SUMMARY OF THE INVENTION

### Object of the Invention

With a wide cylindrical roller bearing which is so wide that if a single cylindrical roller is received in each pocket, it is necessary to use cylindrical rollers which are relatively long compared to their diameters, since such rollers tend to skew during operation, two shorter cylindrical rollers are sometimes received in each pocket such that they are axially aligned with each other.

In this arrangement, it is necessary to push two cylindrical rollers into each pocket. By pushing two cylindrical rollers into each pocket, there is the possibility of galling. Since two cylindrical rollers have to be separately pushed into each pocket, the number of assembling steps is large.

An object of the present invention is to reduce the number of times cylindrical rollers are pushed into the respective pockets of a one-piece retainer such that two of the cylindrical rollers are received in every pocket while being axially aligned with each other.

### Means for Achieving the Object

In order to achieve this object, the present invention provides a cylindrical roller bearing comprising; first cylindrical rollers; second cylindrical rollers; and a one-piece retainer formed with pockets circumferentially arranged at predetermined intervals, wherein each of the first cylindrical rollers and each of the second cylindrical rollers are received in a respective one of the pockets so as to be axially aligned with each other, wherein the retainer includes: crossbars that separate the respective circumferentially adjacent pairs of pockets from each other; pairs of end surface portions, each pair being on the respective sides of, and defining an axial width of, a respective one of the pockets; first anti-separation portions configured to prevent separation of the first cylindrical rollers from the respective pockets; and second anti-separation portions configured to prevent separation of the second cylindrical rollers from the respective pockets, wherein the axial distance between each first anti-separation portions and the corresponding second anti-separation portions is larger than one of the length of the corresponding first cylindrical roller and the length of the corresponding second cylindrical rollers.

With this arrangement, since the axial distance between each first anti-separation portion and the corresponding second anti-separation portion is larger than one of the length of the corresponding first cylindrical roller and the length of the corresponding second cylindrical roller, by first inserting one of the two cylindrical rollers which is shorter than the non-anti-separation area between the first and second anti-separation portion, through this non-anti-separation area into the pocket, this cylindrical roller can be inserted into the pocket without encountering resistance. Then, after moving this cylindrical roller toward the first anti-separation portion or the second anti-separation portion, the other cylindrical roller can be pushed into the pocket. Thus, it is necessary to push only one of the two cylindrical rollers into the pocket.

### Advantages of the Invention

According to the present invention, in the manner described above, it is possible to reduce the number of times cylindrical rollers are pushed into the respective pockets of a one-piece retainer such that two of the cylindrical rollers are received in every pocket while being axially aligned with each other.

### BRIEF DESCRIPTION OF THE DRAWINGS

FIG. 1 schematically illustrates the axial positional relationship between anti-separation portions of a retainer according to a first embodiment of the present invention, and a cylindrical roller to be inserted into a respective pocket of the retainer.

FIG. 2 is a sectional view of a cylindrical roller bearing of the first embodiment, showing its entity.

FIG. 3 schematically illustrates how anti-separation portions of a retainer of a second embodiment prevent separation of two cylindrical rollers from the corresponding pocket of the retainer.

FIG. 4 is a partial developed view of a retainer of a third embodiment, as seen from the side of the retainer where there are anti-separation portions, showing how two cylindrical rollers are received in each pocket of the retainer.

FIG. 5 is a partial sectional view of a fourth embodiment as seen from a circumferential direction, showing anti-separation portions.

FIG. 6 is a partial sectional view of the fourth embodiment, taken along line VI-VI of FIG. 5, and showing cylindrical rollers received in a pocket.

FIG. 7 is a partial sectional view of a fifth embodiment, taken along the line corresponding to line VI-VI of FIG. 5, and showing cylindrical rollers received in a pocket.

FIG. 8 is a partial sectional view of a sixth embodiment, showing anti-separation portions as seen in a circumferential direction.

### BEST MODE FOR EMBODYING THE INVENTION

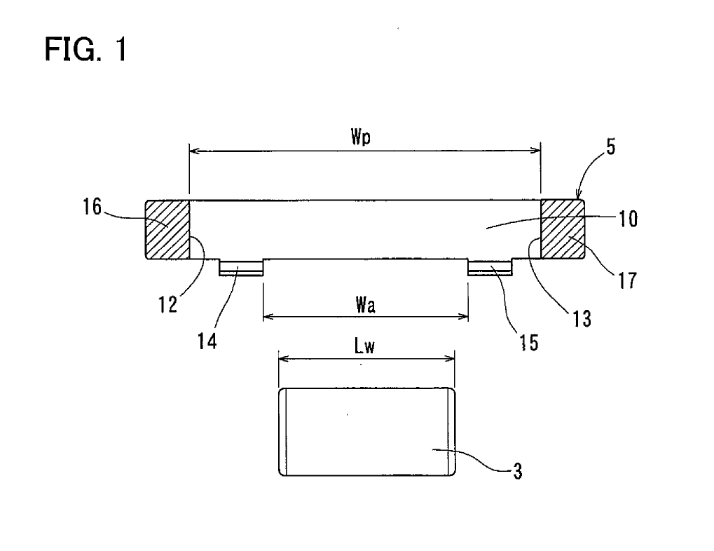

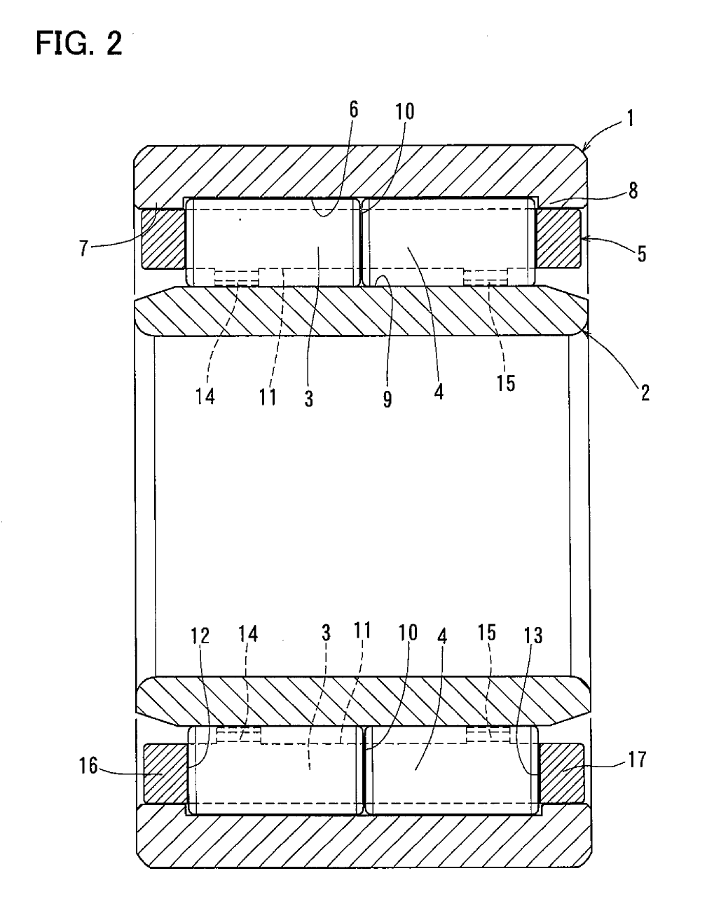

The cylindrical roller bearing according to the first embodiment of the present invention is now described with reference to FIGS. 1 and 2. As shown in FIGS. 1 and 2, this cylindrical roller bearing includes a first bearing race 1, a second bearing race 2, and first cylindrical rollers 3 and second cylindrical rollers 4. The first and second cylindrical rollers 3 and 4 are disposed between the first and second bearing races 1 and 2, and retained by a retainer 5. The direction parallel to the center axis of the retainer 5 is hereinafter simply referred to as “the axial direction”, “axial” or “axially”. The direction perpendicular to the center axis of the retainer 5 is hereinafter simply referred to as “the radial direction”, “radial” or “radially”. The circumferential direction around the center axis of the retainer 5 is hereinafter simply referred to as “the circumferential direction”, “circumferential” or “circumferentially”.

The first bearing race 1 has a first raceway 6, and includes integral first and second flanges 7 and 8. The second bearing race 2 has a second raceway 9 radially opposed to the first raceway 6. The first cylindrical rollers 3 and the second cylindrical rollers 4 are disposed between the first raceway 6 and the second raceway 9.

The first cylindrical rollers 3 have diameters equal to the diameters of the second cylindrical rollers 4, and have lengths equal to the lengths of the second cylindrical rollers 4. The lengths of the first and second cylindrical rollers 3 and 4 are larger than the diameters of the first and second cylindrical rollers 3 and 4.

The retainer 5 is a one-piece retainer formed with pockets 10 circumferentially spaced apart from each other at predetermined intervals, and each receiving one of the first cylindrical rollers 3 and one of the second cylindrical rollers 4 such that the two rollers 3 and 4 are aligned in the axial direction. The retainer 5 includes crossbars 11 each separating a corresponding circumferentially adjacent pair of the pockets 10, and first end surface portions 12 on one side of the retainer and second end surface portions 13 on the other side of the retainer, the first and second end surface portions 12 and 13 defining the axial widths Wp of the pockets 10. The retainer 5 further includes first anti-separation portions 14 configured to prevent separation of the first cylindrical rollers 3 from the respective pockets 10, and second anti-separation portions 15 configured to prevent separation of the second cylindrical rollers 4 from the respective pockets 10.

The method of manufacturing the retainer 5 is not limited, provided the retainer is a one-piece retainer formed entirely of a single component. For example, the retainer may be a one-piece resin retainer formed entirely of a resin, a machined retainer formed entirely by machining a single material, or a one-piece pressed retainer formed entirely by pressing.

The pockets 10 are spaces formed in the retainer 5 such that one of the first cylindrical rollers 3 and one of the second cylindrical rollers 4 are received in each pocket 10 so as to be aligned in the axial direction. The crossbars 11 are integral with a first annular portion 16 and a second annular portion 17 of the retainer 5. The first end surface portions 12 are wall surfaces of the first annular portion 16 that are integral with the respective circumferentially adjacent crossbars 11. The second end surface portions 13 are wall surfaces of the second annular portion 17 that are integral with the respective circumferentially adjacent crossbars 11. The axial width Wp of each pocket 10 is equal to the sum of the lengths of the first cylindrical roller 3 and the second cylindrical roller 4, and a predetermined axial pocket clearance.

The first anti-separation portions 14 and the second anti-separation portions 15 are protruding pieces radially protruding from the crossbars 11 such that a pair of the first anti-separation portions 14, as well as a pair of the second anti-separation portion 15, are circumferentially opposed to each other, while being circumferentially spaced apart from each other by a distance smaller than the diameters of the cylindrical rollers. The first anti-separation portions 14 and the second anti-separation portions 15 are configured not to contact the first cylindrical rollers 3 and the second cylindrical rollers 4, respectively, while the cylindrical rollers are rolling between the first raceway 6 and the second raceway 9.

The axial distance Wa between each first anti-separation portion 14 and the corresponding second anti-separation portion 15 is larger than the lengths Lw of the first cylindrical rollers 3 and the second cylindrical rollers 4. The space between the portions of each adjacent pair of the crossbars 11 having the axial length Wa is larger in circumferential dimension than the diameters of the cylindrical rollers, and thus forms a non-anti-separation area through which the first and second cylindrical rollers 3 and 4 can separate from the pocket 10.

The pair of first anti-separation portions 14 and the pair of second anti-separation portions 15 are arranged to prevent the first cylindrical roller 3 and the second cylindrical roller 4 from separating from the pocket 10 through the areas other than the above-mentioned non-anti-separation area, i.e., the area having the axial length Wa. The axial distance between each first anti-separation portion 14 and the corresponding first end surface portion 12, as well as the axial distance between each second anti-separation portion 15 and the corresponding second end surface portion 13, is smaller than the lengths Lw of the first cylindrical rollers 3 and the second cylindrical rollers 4. These axial distances allow smooth elastic deformation of the corresponding first or second anti-separation portions 14, 15 when a first cylindrical roller 3 or a second cylindrical roller 4 is pushed into the corresponding pocket 10.

To assemble the cylindrical roller bearing of the first embodiment, a bearing race assembly is first assembled by arranging the first bearing race 1 and the retainer 5 concentric to each other so that the pockets 10 radially faces the first raceway 6, and inserting the first cylindrical rollers 3 and the second cylindrical rollers 4 into the respective pockets 10. The second bearing race 2 is then arranged coaxially with, and inserted into, the bearing race assembly.

To insert a first cylindrical roller 3 and a second cylindrical roller 4 into each pocket 10, one of the first cylindrical roller 3 and the second cylindrical roller 4 is inserted into the pocket through the non-anti-separation area, i.e., the area defined between the first anti-separation portions 14 and the second anti-separation portions 15 and having the axial length Wa, without encountering resistance, and is moved toward one axial side of the pocket 10 where there are the first or second anti-separation portions 14, 15 corresponding to the one of the first and second cylindrical rollers 3 and 4. Then, the other of the first cylindrical roller 3 and the second cylindrical roller 4 is pushed into the pocket 10 by forcibly passing it through the space between either the first anti-separation portions 14 or the second anti-separation portions 15 corresponding to the other of the first and second cylindrical rollers 3 and 4. Thus, a cylindrical roller 3 and a cylindrical roller 4 can be inserted into each pocket 10 by pushing only one of the two cylindrical rollers into the pocket 10. Once the first cylindrical roller 3 and the second cylindrical roller 4 are inserted in the pocket 10 while being aligned in the axial direction, the end surfaces of the two cylindrical rollers contact each other at or around the axial center of the width Wp of the pocket such that the two cylindrical rollers restrict each other's axial movement. Thus, either of the first cylindrical roller 3 and the second cylindrical roller 4 is unable to move to a position where it is entirely located in the non-anti-separation area having the axial length Wa, and thus remains in a position where it is prevented from separating from the pocket 10 by the first anti-separation portions 14 or the second anti-separation portions 15. In the above manner, a first cylindrical roller 3 and a second cylindrical roller 4 can be inserted in each pocket 10 of the one-piece retainer 5, while being aligned in the axial direction, by pushing only one of the two cylindrical rollers 3 and 4 into the pocket 10.

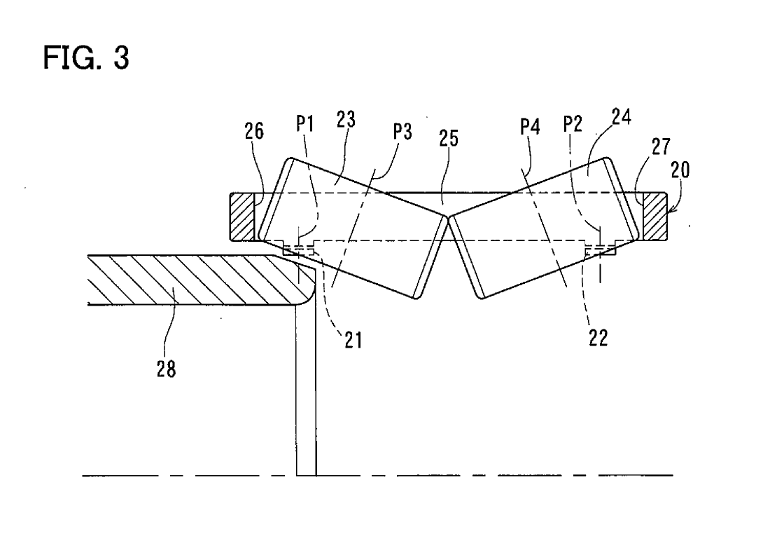

FIG. 3 illustrates the second embodiment. Here, only what differs from the first embodiment is described. FIG. 3 shows, in one-dot chain lines, the axial central position p1 of each first anti-separation portion 21 of the retainer 20 of the second embodiment, the axial central position p2 of each second anti-separation portion 22 of the retainer 20, the longitudinal central position p3 of each first cylindrical roller 23 of the retainer 20, and the longitudinal central position p4 of each second cylindrical roller 24 of the retainer 20. Axial central positions p1 and p2 are positions bisecting the distances between the ends of the first anti-separation portion 21 and between the ends of the second anti-separation portion 22. Longitudinal central positions p3 and p4 are positions bisecting the lengths of the first and second cylindrical rollers 23 and 24, respectively.

The axial central position p1 of the first anti-separation portion 21 is located closer to the first end surface portion 26, which is located closer to the first anti-separation portion 21, than is the longitudinal central position p3 of the first cylindrical roller 23 in the corresponding pocket 25. The axial central position p2 of the second anti-separation portion 22 is located closer to the second end surface portion 27, which is located closer to the second anti-separation portion 22, than is the longitudinal central position p4 of the second cylindrical roller 24 in the corresponding pocket 25.

With this arrangement, while the first cylindrical roller 23 and the second cylindrical roller 24 in each pocket 25 are being prevented from separation from the pocket 25 by the corresponding pair of first anti-separation portions 21 and the corresponding pair of second anti-separation portions 22, respectively, since the first anti-separation portions 21 contact the portion of the first cylindrical roller 23 located closer to the first end surface portion 26, the first cylindrical roller 23 tends to be inclined such that its end facing the second cylindrical roller 24 moves radially inward. Similarly, since the second anti-separation portions 22 contact the portion of the second cylindrical roller 24 located closer to the second end surface portion 27, the second cylindrical roller 24 tends to be inclined such that its end facing the first cylindrical roller 23 moves radially inward. When the first cylindrical roller 23 and the second cylindrical roller 24 are inclined in the above-described manner, they abut each other, and are unable to separate from the pocket 25. With the first cylindrical roller 23 and the second cylindrical roller 24 inclined in the above-described manner, when the second bearing race 28 is inserted into the bearing race assembly, the cylindrical rollers 23 and 24 move gradually toward the uninclined positions due to contact with the second bearing race 28, until, finally, the end faces of the cylindrical rollers 23 and 24 axially face each other. Thus, in the second embodiment, it is possible to more easily insert the second bearing race 28 into the bearing race assembly, while preventing the possibility of galling. FIG. 3 shows the inclined conditions of the cylindrical rollers 23 and 24 in an exaggerated manner. Actually, the cylindrical rollers 23 and 24 cannot incline any further once they contact the raceway of the first bearing race, not shown.

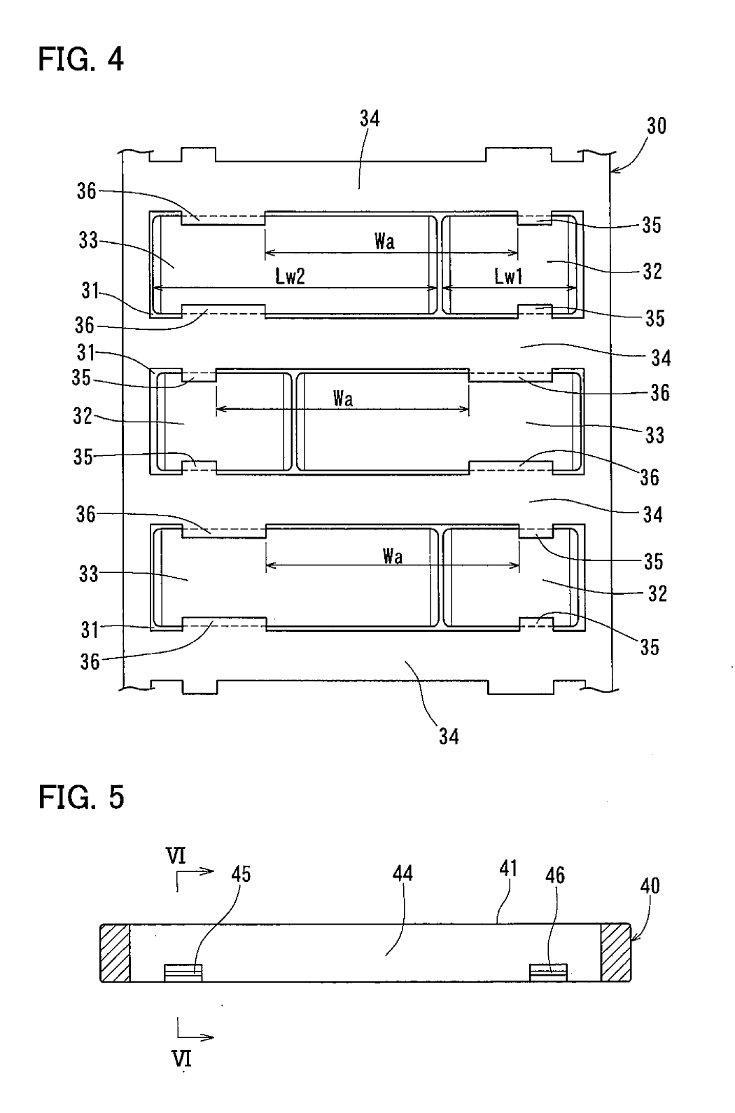

FIG. 4 shows the retainer 30 of the third embodiment, of which each first cylindrical roller 32 has a length Lw1 which is different from the length Lw2 of each second cylindrical roller 33, and the first cylindrical roller 32 and the second cylindrical roller 33 in one of each circumferentially adjacent pair of the pockets 31 of the retainer 30 are axially arranged in the opposite manner to the first cylindrical roller 32 and the second cylindrical roller 33 in the other of the circumferentially adjacent pair of pockets 31. Thus, in the third embodiment, it is possible to prevent concentration of, i.e., disperse, the stress on the respective bearing races, and thus to prolong the lifetime of the bearing.

Corresponding to the axial arrangements of the first and second cylindrical rollers 32 and 33 in the respective pockets 31, the first anti-separation portions 35 and the second anti-separation portions 36 which circumferentially protrude from the crossbars 34 are also arranged axially in the opposite manner between each circumferentially adjacent pair of the pockets 31. In particular, when considering the three vertically arranged pockets 31 in FIG. 4, since in the uppermost pocket 31, the first cylindrical roller 32 is on the right side (in FIG. 4) of the second cylindrical roller 33, the corresponding pair of first anti-separation portions 35 are located on the right side (in FIG. 4) of the crossbars 34, while the corresponding pair of second anti-separation portions 36 are located on the left side (in FIG. 4) of the crossbars 34. In the middle pocket 31, since the second cylindrical roller 33 is on the right side (in FIG. 4) of the first cylindrical roller 32, the corresponding pair of first anti-separation portions 35 is on the left side (in FIG. 4) of the crossbars 34, while the corresponding pair of second anti-separation portions 36 are located on the right side of the crossbars 34. The anti-separation portions corresponding to the lowermost pocket 31 are arranged in the same manner as those corresponding to the uppermost pocket 31.

For any of the pockets 31, the axial distance Wa between each of the pair of first anti-separation portions 35 and the corresponding one of the pair of second anti-separation portions 36 is larger than the smaller one of the lengths Lw1 of the first cylindrical roller 32 and the length Lw2 of the second cylindrical roller 33, i.e., larger than length Lw1. With this arrangement, it is possible to reduce the ratio of the axial distance Wa to the width of the pocket 31, compared to when distance Wa is larger than the larger length Lw2. This in turn makes it possible to more freely arrange the first anti-separation portions 35 and second anti-separation portions 36. For example, it is possible to use second anti-separation portions 36 having a larger axial width than the first anti-separation portions 35, and support the longitudinally central portion of the longer second cylindrical roller 33 with these wide second anti-separation portions 36, thereby preventing excessive inclination of the second cylindrical roller 33.

While axial distance Wa should ordinarily be smaller than roller length Lw2, the former may be larger than the latter unless this makes it difficult to prevent separation of the first cylindrical roller 32 and the second cylindrical roller 33 from the pocket 31. In this case, either of a first cylindrical roller 32 and a second cylindrical roller 33 may be inserted first into each pocket 31.

In any of the above-described embodiments, the first anti-separation portions and the second anti-separation portions are protruding pieces radially protruding from the crossbars, but they may be shaped otherwise. In any of the above-described embodiments, the first anti-separation portions and the second anti-separation portions are provided on the radially inner portion of the retainer, to assemble a bearing assembly including the outer bearing race as the first bearing race, but the first and second anti-separation portions may be provided on the radially outer portion of the retainer.

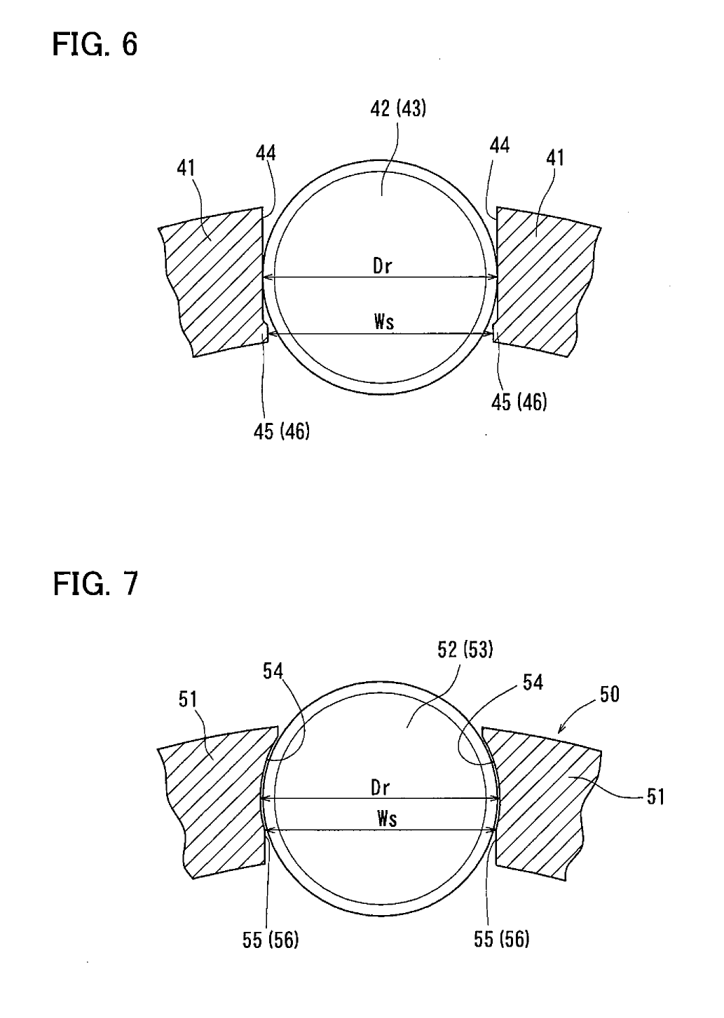

FIGS. 5 and 6 illustrate a fourth embodiment which includes modified first and second anti-separation portions. Each circumferentially adjacent pair of the crossbars 41 of the retainer 40 of the fourth embodiment has, respectively, a pair of straight surfaces 44 opposed to each other while being spaced apart from each other by a distance larger than the diameters Dr of the first and second cylindrical rollers 42 and 43. The distances Ws between each opposed pair of the first anti-separation portions 45 and between each opposed pair of the second anti-separation portions 46 are smaller than the diameters Dr of the first and second cylindrical rollers 42 and 43. The first anti-separation portions 45 and the second anti-separation portions 46 do not radially protrude beyond the crossbars 41. Since the first anti-separation portions 45 and the second anti-separation portions 46 are provided at the radially inner portion of the retainer 40 so as not to protrude radially beyond the rest of the retainer 40, it is possible to simplify the shape of the inner periphery of the retainer 40.

FIG. 7 shows the retainer 50 of the fifth embodiment of which each crossbar 51 has radially outer-side curved surfaces 54 on the radially outer portion of the crossbar 51, each curved surface 54 extending the entire axial length of the retainer 50 along the rolling surfaces of the corresponding first and second cylindrical rollers 52 and 53. One of the first anti-separation portions 55 and one of the second anti-separation portions 56 are protrusions defined by the portion of each curved surface 54 extending from the radially central portion of the curved surface 54 along the rolling surfaces of the first and second cylindrical rollers 52 and 53, and a straight surface extending from this portion of the curved surface 54 to the radially inner surface of the retainer 50. The protrusions forming the first and second anti-separation portions 55 and 56 have ridgelines such that the distances Ws between each opposed pair of the first anti-separation portions 55 and between each opposed pair of the second anti-separation portion 56 are the smallest between the respective ridgelines. In the fifth embodiment, since the first anti-separation portions 55 and the second anti-separation portions 56 are each in the shape of a protrusion having a ridgeline, each first cylindrical roller 52 and each second cylindrical roller 53 can be easily pushed through a corresponding pair of the first anti-separation protrusions 55 and a corresponding pair of the second anti-separation portions 56, respectively.

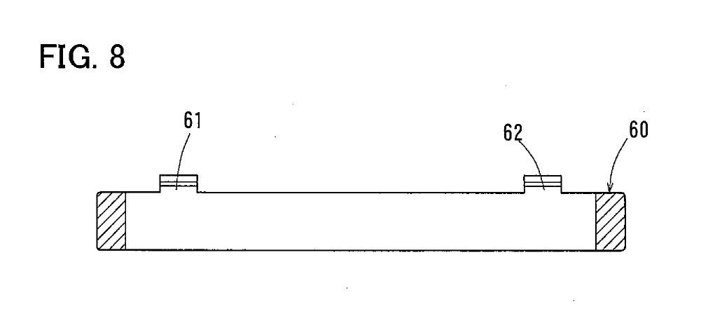

FIG. 8 shows the retainer 60 of the sixth embodiment, in which the first anti-separation portions 61 and the second anti-separation portions 62 are arranged at the radially outer portion of the retainer 60. This retainer 60 can be used to assemble a bearing race assembly including the inner bearing race.

It is to be understood that the embodiments disclosed here are mere examples and are not intended to restrict the present invention in any way. The scope of the present invention is defined by the appended claims and not by the above description of the present invention. The present invention covers and encompasses every modification and alteration that is considered to be within the scope of the claims both literally and equivalently.

### DESCRIPTION OF THE NUMERALS

1. First bearing race
2, 28. Second bearing race
3, 23, 32, 42, 52. First cylindrical roller
4, 24, 33, 43, 53. Second cylindrical roller
5, 20, 30, 40, 50, 60. Retainer
6. First raceway
7. First flange
8. Second flange
9. Second raceway
10, 25, 31. Pocket
11, 34, 41, 51. Crossbar
12, 13, 26, 27. End surface portion
14, 21, 35, 45, 55, 61. First anti-separation portion
15, 22, 36, 46, 56, 62. Second anti-separation portion
16. First annular portion
17. Second annular portion
44. Straight surface
54. Radially outer-side curved surface
Wa: Axial distance
Wp: Pocket width
Lw, Lw1, Lw2. Roller length

1. A cylindrical roller bearing comprising;
first cylindrical rollers;
second cylindrical rollers; and
a one-piece retainer formed with pockets circumferentially arranged at predetermined intervals, wherein each of the first cylindrical rollers and each of the second cylindrical rollers are received in a respective one of the pockets so as to be axially aligned with each other,
wherein the retainer includes:
crossbars that separate respective circumferentially adjacent pairs of the pockets from each other;
pairs of end surface portions, each pair of the end surface portions being on respective sides of, and defining an axial width of, a respective one of the pockets;
first anti-separation portions configured to prevent separation of the first cylindrical rollers from the respective pockets; and
second anti-separation portions configured to prevent separation of second cylindrical rollers from the respective pockets,
wherein an axial distance between each of the first anti-separation portions and a corresponding one of the second anti-separation portions is larger than one of a length of a corresponding one of the first cylindrical rollers and a length of a corresponding one of the second cylindrical rollers.

2. The cylindrical roller bearing of claim 1,
wherein an axial center of each of the first anti-separation portions is located between a center of the length of the first cylindrical roller in a respective one of the pockets, and a first one of a corresponding pair of the end surface portions that is closer to the first anti-separation portion, and
wherein an axial center of each of the second anti-separation portions is located between a center of the length of the second cylindrical roller in a respective one of the pockets, and a second one of a corresponding pair of the end surface portions that is closer to the second anti-separation portion.

3. The cylindrical roller bearing of claim 1,
wherein the lengths of the first cylindrical rollers differ from the lengths of the second cylindrical rollers, and
wherein the first cylindrical roller and the second cylindrical roller in a first one of each circumferentially adjacent pair of the pockets are axially arranged in an opposite manner to the first cylindrical roller and the second cylindrical roller in a second one of the circumferentially adjacent pair of pockets.

4. The cylindrical roller bearing of claim 1, wherein the lengths of the first cylindrical rollers are smaller than the lengths of the second cylindrical rollers, and
wherein the axial distance is larger than the length of a corresponding one of the first cylindrical rollers.

5. The cylindrical roller bearing of claim 2,
wherein the lengths of the first cylindrical rollers differ from the lengths of the second cylindrical rollers, and
wherein the first cylindrical roller and the second cylindrical roller in a first one of each circumferentially adjacent pair of the pockets are axially arranged in an opposite manner to the first cylindrical roller and the second cylindrical roller in a second one of the circumferentially adjacent pair of pockets.

6. The cylindrical roller bearing of claim 2, wherein the lengths of the first cylindrical rollers are smaller than the lengths of the second cylindrical rollers, and
wherein the axial distance is larger than the length of a corresponding one of the first cylindrical rollers.

7. The cylindrical roller bearing of claim 3, wherein the lengths of the first cylindrical rollers are smaller than the lengths of the second cylindrical rollers, and
wherein the axial distance is larger than the length of a corresponding one of the first cylindrical rollers.

8. The cylindrical roller bearing of claim 5, wherein the lengths of the first cylindrical rollers are smaller than the lengths of the second cylindrical rollers, and
wherein the axial distance is larger than the length of a corresponding one of the first cylindrical rollers.
